(19) United States
(12) Patent Application Publication
(10) Pub. No.: US 2012/0034936 A1
(43) Pub. Date: Feb. 9, 2012

(54) ASSOCIATED COMMUNICATION APPARATUS

(75) Inventor: PI-FEN LIN, TAIPEI CITY (TW)

(73) Assignee: SURE BEST LIMITED, APIA (WS)

(21) Appl. No.: 13/272,274

(22) Filed: Oct. 13, 2011

Related U.S. Application Data
(63) Continuation-in-part of application No. 11/832,903, filed on Aug. 2, 2007.

(51) Int. Cl. H04W 4/00

(52) U.S. Cl. 455/462

(57) ABSTRACT

The present invention discloses an associated communication apparatus that includes a telephone transmitter, a telephone base, and a wireless earphone so that user can install the telephone transmitter into the telephone base and can install the wireless earphone into the telephone transmitter. Furthermore, the telephone transmitter can be removed from the base and the wireless earphone can be removed from the telephone transmitter. The present invention provides various means for communication such as the earphone, the telephone transmitter, and the telephone base.

### CROSS REFERENCE TO RELATED APPLICATION

This patent application is claiming priority under 35 U.S.C. 120 as a continuation-in-part patent application of patent application Ser. No. 11/832,903, filed Aug. 2, 2007, currently pending.

### BACKGROUND OF THE INVENTION

1. Field of the Invention

The present invention relates to an associated communication apparatus. In particular, the communication apparatus comprises at least a telephone transmitter, a telephone base, and at least a wireless earphone wherein the apparatus allows multiple incoming calls via the telephone transmitter and/or the wireless earphone simultaneously.

2. Description of Related Art

Reference is made to FIG. 1, which shows a schematic diagram of a traditional telephone set. The telephone set 2 has a communication connecting wire 24 between the dialing host 20 and the transmitter 22. It uses a transmitting wire 26 to connect to the public switch telephone network (PSTN) 7. The user presses the key 28 on the host to make a call, links to a remote person via the PSTN 7, and communicates with the person via the transmitter 22.

However, due to developments in wireless communication technology, the traditional structure of the dialing host 20 connecting with the transmitter 22 via the communication connecting wire 24 has been improved to become a wireless dialing transmitter 2′ and a base station 20′ both having wireless communicating functions. The wireless dialing transmitter 2′ links to the base station 20′ by a wireless method, as shown in FIG. 2. The base station 20′ links to the PSTN 7. Therefore, users can make calls to one another.

Furthermore, Bluetooth® communication is also increasingly being applied to personal portable communication equipment, such as the communication between wireless earphones and cell phones via Bluetooth® protocol. The user can receive a call anywhere, without having to hold on to his or her cell phone.

However, when the user communicates via the traditional telephone set 2 with the communication connecting wire 24, it is inconvenient for the user to communicate by the communication connecting wire 24. When the user communicates via the wireless dialing transmitter 2′ he or she needs to hold the phone close to their ear to hear incoming sounds. If the user is involved in a long call or uses the phone for extended periods, the user's arm can start to ache. Hence, communication quality is reduced.

To sum up, users wish to receive calls anywhere without holding their transmitter and have excellent communication quality in their life. The present invention aims to provide users with a device that meets these wishes.

### SUMMARY OF THE INVENTION

One aspect of the present embodiment is to provide an associated communication apparatus that includes a telephone transmitter, a telephone base, and a wireless earphone. The user may place the telephone transmitter into the base and may place the wireless earphone into the telephone transmitter. Furthermore, the telephone transmitter may be removed from the base and the wireless earphone may be removed from the telephone transmitter. The present invention provides various means for communication, such as the earphone, the telephone transmitter, and the telephone base. Furthermore, the telephone base could receive the earphone so as to provide another means of communication to user.

In another aspect of the present embodiment is to provide an associated communication apparatus that allows for plural phone calls engaged concurrently, and provide a private manner for telephone communication so that the content of the communication would not be revealed to other people, while a public manner is also introduced for easily holding a conference call.

The first embodiment of the present invention comprises a telephone base, a telephone transmitter, and a wireless earphone. The telephone base has a telephone-controller disposed internally therein and a transmitter receiving slot disposed externally thereon, wherein the telephone-controller is used to provide a PSTN call service and the transmitter receiving slot configures a first connecter connected to the telephone-controller. The telephone transmitter has a transmitter-controller disposed internally therein and an earphone receiving slot, a first signal transmitting terminal disposed externally thereon, wherein the earphone receiving slot configures a second connecter. The first signal transmitting terminal and the second connecter connect to the transmitter-controller, and the first signal transmitting terminal connects to the first connecter while the transmitter receiving slot receives the telephone transmitter. The wireless earphone has an earphone controller disposed internally therein and a second signal transmitting terminal disposed externally thereon, wherein the second signal transmitting terminal connects to the earphone controller, and connects to the second connecter while the earphone receiving slot receives the wireless earphone.

Moreover, the second embodiment of the present invention comprises a telephone base, a telephone transmitter, and a wireless earphone. The telephone base has a telephone-controller disposed internally therein and a transmitter receiving slot disposed externally thereon, wherein the telephone-controller is used to provide a PSTN call service and the transmitter receiving slot configures a hook switch connected to the telephone-controller. The telephone transmitter has a transmitter-controller disposed internally therein and an earphone receiving slot disposed externally thereon, wherein the earphone receiving slot configures a connecter. The transmitter-controller connects to the connecter and to the telephone base via a communication connecting wire. The wireless earphone has an earphone controller internally and a signal transmitting terminal externally, wherein the signal transmitting terminal connects to the earphone controller, and connects to the connecter while the earphone receiving slot receives the wireless earphone.

Furthermore, the third embodiment of the present invention comprises a telephone base and a wireless earphone. The telephone base has a telephone-controller internally and an earphone receiving slot externally, wherein the telephone-controller is used to provide a PSTN call service and the earphone receiving slot configures a connecter connected to the telephone-controller. The wireless earphone has an earphone controller internally and a signal transmitting terminal externally, wherein the signal transmitting terminal connects to the earphone controller, and connects to the connecter while the earphone receiving slot receives the wireless earphone.

Additionally, another embodiment of the present invention illustrates a telephone base, a telephone transmitter, a wireless earphone, and a function key. The telephone base includes a telephone controller for providing PSTN phone call service and transmitting or receiving sound signals, a transmitter receiving slot having a first connector for receiving the telephone transmitter, a microphone, and a loud speaker. The telephone transmitter is coupled to the telephone controller for outputting the sound signals from the telephone controller and receiving a voice signal of a user. The telephone transmitter has a first signal transmitting terminal used to connect with the first connector when the telephone transmitter is received in the transmitter receiving slot, and an earphone receiving slot having a second connector for receiving the wireless earphone. The wireless earphone has a second signal transmitting terminal used to connect with the second connector when the wireless earphone is received in the earphone receiving slot. The function key is coupled to the telephone controller and used to generate an activating signal when being pressed. When the telephone base receives the sound signals of a first phone call and the sound signals of a second phone call through the PSTN while the wireless earphone and the transmitter are both removed from the earphone receiving slot and the transmitter receiving slot, the telephone controller transmits the sound signals of the first phone call and the sound signals of the second phone call to the wireless earphone and the transmitter, respectively. On the other hand, when the wireless earphone and the transmitter are used to communicate with the phone call terminal of the first phone call and the phone call terminal of the second phone call, and the telephone controller receives the activating signal, the telephone controller determines whether the wireless earphone is received in the earphone receiving slot and the transmitter is received in the transmitter receiving slot, and the sound signals of the first phone call and the second phone are switched to the loud speaker and the voice signal of the user is received from the microphone when the wireless earphone and the transmitter are determined to be received in the corresponding slot.

In another embodiment, both of the transmitter receiving slot and the earphone receiving slot are disposed on the telephone base with the first connector and the second connector connecting to the telephone controller. The telephone controller determines to transmit the sound signals of the phone calls to the wireless earphone and the telephone transmitter, or switch the sound signals to the loud speaker according to whether the wireless earphone and the telephone transmitter are received in the corresponding slot.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is a schematic diagram of a traditional telephone set;

FIG. 2 is a schematic diagram of the traditional wireless telephone set;

FIG. 3 is a schematic diagram of the appearance of the first embodiment of the present invention;

FIG. 4 is a schematic diagram of the appearance of the second embodiment of the present invention;

FIG. 5 is a schematic diagram of the appearance of the third embodiment of the present invention;

FIG. 6 is a block diagram of the associated communication apparatus according to one embodiment of the present invention;

FIG. 7 is a schematic diagram of the appearance of the fourth embodiment of the present invention;

FIG. 8 is a block diagram of the associated communication apparatus according to another embodiment of the present invention;

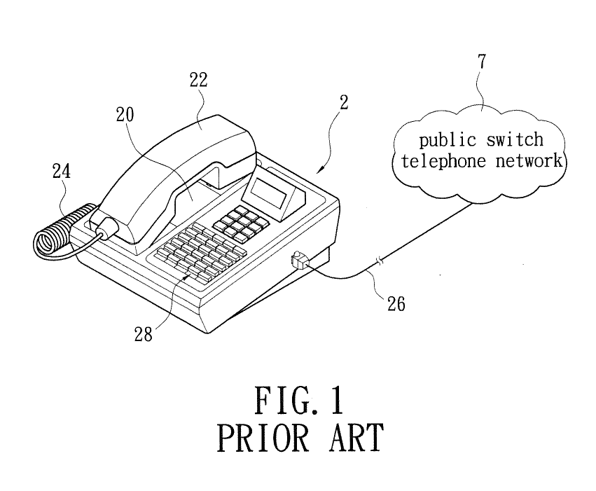

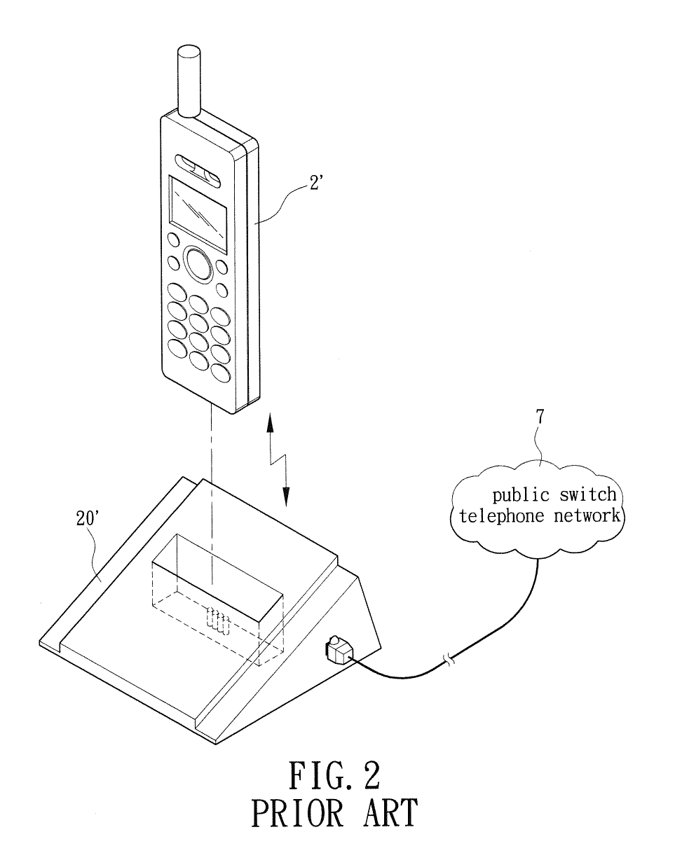

### DETAILED DESCRIPTION OF THE PREFERRED EMBODIMENTS

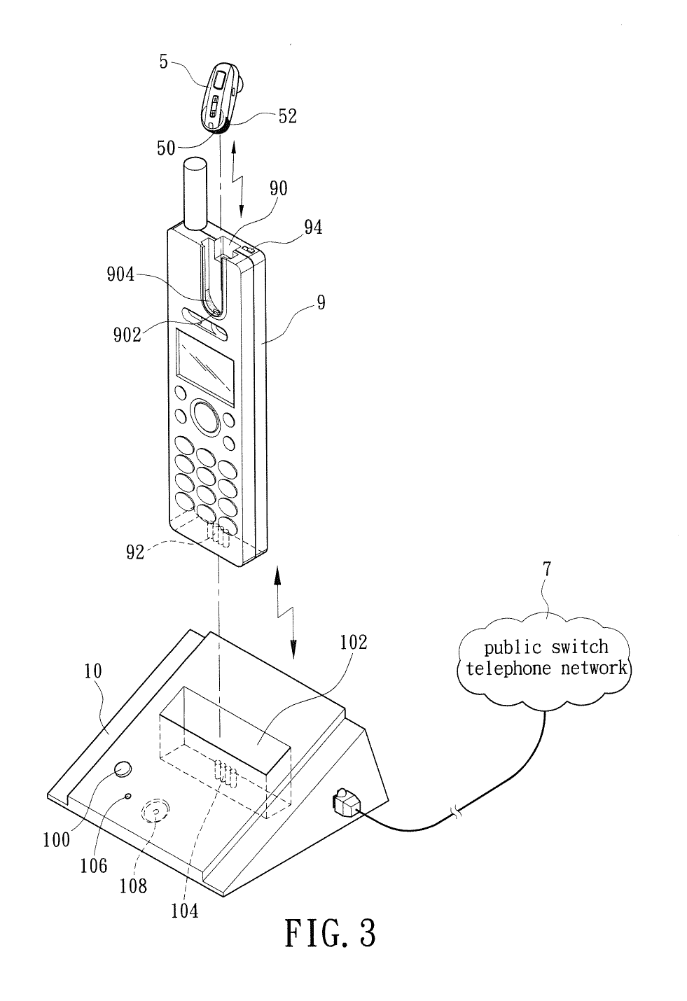

Reference is made to FIG. 3, which shows a schematic diagram of the appearance of the first embodiment of the present invention. The associated communication apparatus includes a telephone base 10, a telephone transmitter 9, and a wireless earphone 5. The wireless earphone 5 may be a Bluetooth earphone, and the telephone transmitter 9 may be a wireless DECT handset. The telephone base 10 has a telephone controller (not shown) disposed internally therein and a transmitter receiving slot 102 disposed externally thereon, wherein the telephone-controller is used to provide a PSTN call service and the transmitter receiving slot 102 configures a first connecter 104 connected to the telephone-controller. The telephone base 10 further has a function key 100 for generating an activating signal to the telephone controller, a microphone 106 for receiving voice signals of a user, and a loud speaker 108 for broadcasting sound signals of the received phone call. The telephone transmitter 9 has a transmitter-controller (not shown) internally and an earphone receiving slot 90, a first signal transmitting terminal 92 externally, wherein the earphone receiving slot 90 configures a second connecter 902, the first signal transmitting terminal 92 and the second connecter 902 connect to the transmitter-controller, and the first signal transmitting terminal 92 connects to the first connecter 104 while the transmitter receiving slot 102 receives the telephone transmitter 9.

The wireless earphone 5 has an earphone controller (not shown) internally and a second signal transmitting terminal 50 externally, wherein the second signal transmitting terminal 50 connects to the earphone controller, and connects to the second connecter 902 while the earphone receiving slot 90 receives the wireless earphone 5.

Reference is made to FIG. 3 again. The telephone base 10 is linked to a PSTN 7 in a wired manner and communicates with a terminal (not shown) via the PSTN 7. Moreover, a user utilizes the telephone base 10 to communicate with a terminal via either a hands-free or speaker method, while the telephone base 10 receives the telephone transmitter 9 that has received the wireless earphone 5.

Furthermore, the user can remove the telephone transmitter 9 from the telephone base 10 and communicate with a terminal by holding the telephone transmitter 9. At this time, the user can also remove the wireless earphone 5 from the telephone transmitter 9 and communicate with a terminal by the wireless earphone 5 to make a private call. In the manner mentioned above, when the telephone transmitter 9 is removed from the telephone base 10, the telephone transmitter 9 and the telephone base 10 communicate with each other via Bluetooth. Similarly, when the wireless earphone 5 is removed from the telephone transmitter 9, the wireless earphone 5 and the telephone transmitter 9 also communicate with each other via Bluetooth.

Reference is made to FIG. 3 again. In order to rapidly connect the wireless earphone 5 with the telephone transmitter 9, the wireless earphone 5 further includes an attractable element 52, and a magnetic element 904 in the earphone receiving slot 90 of the telephone transmitter 9. When the wireless earphone 5 nears the earphone receiving slot 90 of the telephone transmitter 9, the magnetic attracting effect generated by the magnetic element 904 attracts the attractable element 52 of the wireless earphone 5. Thereby, the wireless earphone 5 is rapidly received in the earphone receiving slot 90 and the signal transmitting terminal 50 of the wireless earphone 5 is electrically connected with the second connector 902 of the telephone transmitter 9.

Reference is made to FIG. 3 again. The first signal transmitting terminal 92 of the telephone transmitter 9 and the first connecter 104 of the telephone base 10 are connected via a USB interface or a metallic contact interface. Similarly, the second signal transmitting terminal 50 of the wireless earphone 5 and the second connecter 902 of the telephone transmitter 9 are connected via a USB interface or a metallic contact interface. Moreover, the telephone transmitter 9 further comprises a lock machine 94 wherein the lock machine 94 is embedded in the telephone transmitter 9 for locking the wireless earphone 5 in the earphone receiving slot 90 so as to ensure that the wireless earphone 4 does not fall out or become misplaced.

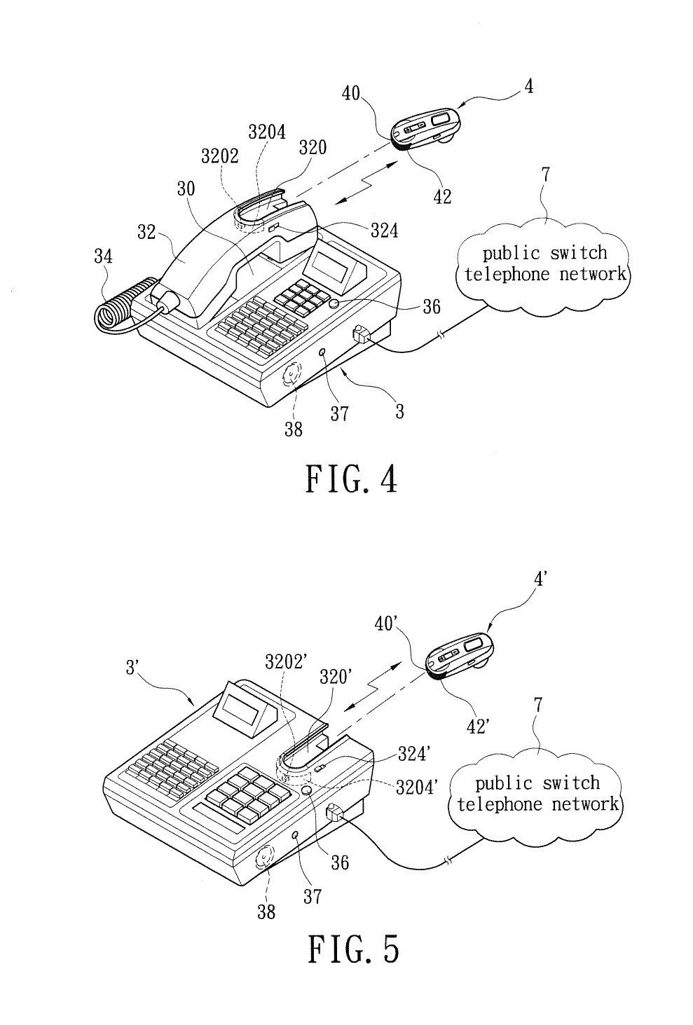

Reference is made to FIG. 4, which shows a schematic diagram of the appearance of the second embodiment of the present invention. The associated communication apparatus includes a telephone base 3, a telephone transmitter 32, and a wireless earphone 4. The telephone base 3 has a telephone controller (not shown) internally and a transmitter receiving slot 30 externally, wherein the telephone controller is used to provide a PSTN call service and the transmitter receiving slot 30 configures a hook switch (not shown) connected to the telephone controller. A function key 36, a microphone 37, and a loud speaker 38 are disposed on the telephone base 3, too. The telephone transmitter 32 has a transmitter controller (not shown) internally and an earphone receiving slot 320 externally, wherein the earphone receiving slot 320 configures a connecter 3202, and the transmitter-controller connects to the connecter 3202 and to the telephone base 3 via a communication connecting wire 34. The wireless earphone 4 has an earphone controller (not shown) internally and a signal transmitting terminal 40 externally, wherein the signal transmitting terminal 40 connects to the earphone controller, and connects to the connecter 3202 while the earphone receiving slot 320 receives the wireless earphone 4.

Reference is made to FIG. 4 again. The telephone base 3 is linked to a PSTN 7 in a wired manner and communicated with a terminal (not shown) via the PSTN 7. Moreover, user utilizes the telephone base 3 to communicate with a terminal by holding the telephone transmitter 32. Furthermore, the user can remove the wireless earphone 4 from the telephone transmitter 32 and communicates with a terminal by wireless earphone 4, and a private call is made.

In the mention of the above, when the telephone transmitter 32 is removed from the telephone base 3, the hook switch is acted. At this time, the transmission of sound signal is come from the terminal and through the PSTN 7, the telephone-controller of the telephone base 3, the communication connecting wire 34 and the transmitter-controller of the telephone transmitter 32 to form the duplex transmission.

Moreover, when the wireless earphone 4 is removed from the telephone transmitter 32 the transmitter-controller of the telephone transmitter 32 informs the telephone-controller of the telephone base 3 to form a wireless transmission with the wireless earphone 4. At this time, the transmission of sound signals comes from the terminal and through the PSTN 7, the telephone-controller of the telephone base 3 and the wireless earphone 4 to form a duplex transmission.

Reference is made to FIG. 4 again. In order to rapidly connect the wireless earphone 4 with the telephone transmitter 32, the wireless earphone 4 further includes an attractable element 42 and a magnetic element 3204 in the earphone receiving slot 320 of the telephone transmitter 32. When the wireless earphone 4 nears the earphone receiving slot 320 of the telephone transmitter 32, the magnetic attracting effect generated by the magnetic element 3204 attracts the attractable element 42 of the wireless earphone 4. Thereby, the wireless earphone 4 is rapidly received in the earphone receiving slot 320, and the signal transmitting terminal 40 of the wireless earphone 4 is electrically connected with the connector 3202 of the telephone transmitter 32.

Reference is made to FIG. 4 again. The signal transmitting terminal 40 of the wireless earphone 4 and the connecter 3202 of the telephone transmitter 32 are connected via a USB interface or a metallic contact interface. Moreover, the telephone transmitter 32 further comprises a lock machine 324, wherein the lock machine 324 is embedded in the telephone transmitter 32 for locking the wireless earphone 4 in the earphone receiving slot 320 so as to ensure that the wireless earphone 4 does not fall out or become misplaced.

Reference is made to FIG. 5, which shows a schematic diagram of the appearance of the third embodiment of the present invention. The associated communication apparatus includes a telephone base 3′ and a wireless earphone 4′. The telephone base 3′ has a telephone-controller (not shown) internally and an earphone receiving slot 320′ externally, wherein the telephone-controller is used to provide a PSTN call service and the earphone receiving slot 320′ configures a connecter 3202′ connected to the telephone-controller. The wireless earphone 4′ has an earphone controller (not shown) internally and a signal transmitting terminal 40′ externally, wherein the signal transmitting terminal 40′ connects to the earphone controller, and connects to the connecter 3202′ while the earphone receiving slot 320′ receives the wireless earphone 4′.

Reference is made to FIG. 5 again. The telephone base 3′ is linked to a PSTN 7 in a wired manner and communicates with a terminal (not shown) via the PSTN 7. Moreover, the user can remove the wireless earphone 4′ from the telephone base 3′ and communicate with a terminal via the wireless earphone 4′ to make a private call.

In the description mentioned above, when the wireless earphone 4′ is removed from the telephone base 3′, the telephone-controller of the telephone base 3′ is built the wireless communication with the wireless earphone 4′. At this time, the transmission of sound signal comes from the terminal and through the PSTN 7. The telephone-controller of the telephone base 3′ and the wireless earphone 4′ form the duplex transmission.

Reference is made to FIG. 5 again. In order to rapidly connect the wireless earphone 4′ with the telephone base 3′, the wireless earphone 4′ further includes an attractable element 42′, and a magnetic element 3204′ in the earphone receiving slot 320′ of the telephone base 3′. When the wireless earphone 4′ nears the earphone receiving slot 320′ of the telephone base 3′, the magnetic attracting effect generated by the magnetic element 3204′ attracts the attractable element 42′ of the wireless earphone 4′. Thereby, the wireless earphone 4′ is rapidly received in the earphone receiving slot 320′, and the signal transmitting terminal 40′ of the wireless earphone 4′ is electrically connected with the connector 3202′ of the telephone base 3′.

Reference is made to FIG. 5 again. The signal transmitting terminal 40′ of the wireless earphone 4′ and the connecter 3202′ of the telephone base 3′ are connected via a USB interface or a metallic contact interface. Moreover, the telephone base 3′ further comprises a lock machine 324′, wherein the lock machine 324′ is embedded in the telephone base 3′ for locking the wireless earphone 4′ in the earphone receiving slot 320′ so as to ensure that the wireless earphone 4′ does not fall out or become misplaced.

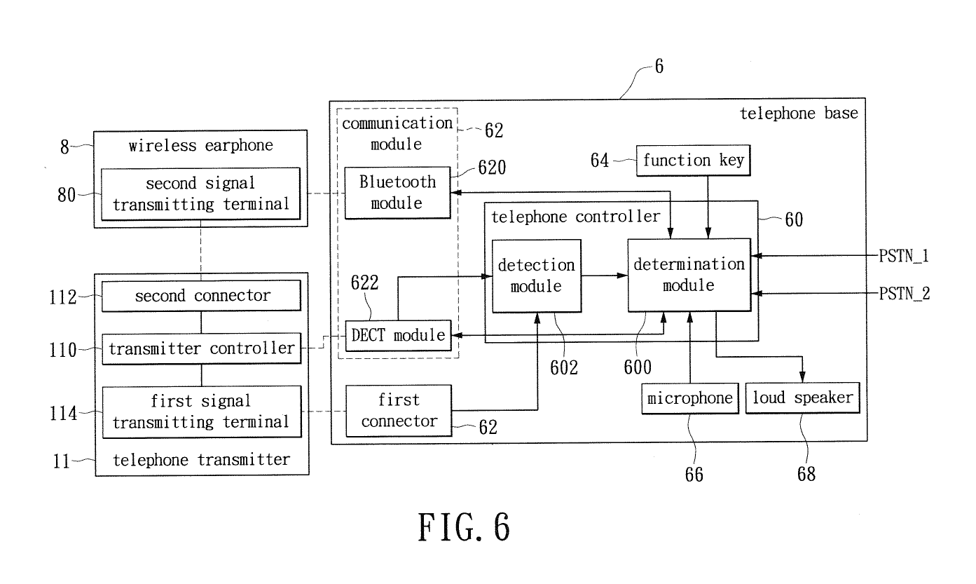

Please refer to FIG. 6, which shows a block diagram of a communication apparatus according to an embodiment of the present invention. The telephone base 6 includes a telephone controller 60, a communication module 62, a function key 64, a microphone 66, a loud speaker 68, and a first connector 67. The telephone controller 60 further includes a determination module 600 and a detection module 602. The telephone controller 60 may be a Digital Signal Processor (DSP) or a Micro Control Unit (MCU) capable of executing a series of commands and instructions. The communication module 62 may include a Bluetooth module 620 and a DECT module 622. The first connector 67, the detection module 602, the function key 64, the microphone 66, and the loud speaker 68 are respectively connected with the determination module 600.

The wireless earphone 8 includes a second signal transmitting terminal 80. The telephone transmitter 11 including a transmitter-controller 110, a second connector 112, and a first signal transmitting terminal 114 may be communicated with the telephone base 6 in a wired or wireless manner. The wireless earphone 8 may be a Bluetooth earphone in the present embodiment which is used to communicate with the telephone base 6 through the Bluetooth module 620. The telephone transmitter 11 may be a wireless DECT handset in the present embodiment which is used to communicate with the telephone base 6 through the DECT module 622. The transmitter controller 110 of the telephone transmitter 11 is electronically connected with the second connector 112 and the first signal transmitting terminal 114. The second signal transmitting terminal 80 may be electronically connected with the second connector 112 when the wireless earphone 8 is received within the telephone transmitter 11. Also, the first signal transmitting terminal 114 of the telephone transmitter 11 may be electronically connected with the first connector 67 of the telephone base 6 when the telephone transmitter 11 is received within the telephone base 6.

The transmitter controller 110 may transmit a connection signal to the detection module 602 of the telephone base 6 through the DECT module 622 when the second signal transmitting terminal 80 is electronically connected with the second connector 112. Furthermore, the detection module 602 may detect the connection between the first signal transmitting terminal 114 and the first connector 67. The detection module 602 may also be informed of disconnection between the second signal transmitting terminal 80 and the second connector 112, as well as the disconnection between the first signal transmitting terminal 114 and the first connector 67 via the same manners. Therefore, the determination module 600 connected with the detection module 602 may determine whether the wireless earphone 8 is removed from the telephone transmitter 11 and whether the telephone transmitter 11 is removed from the telephone base 6 by analyzing the detection result of the detection module 600.

The telephone base 6 may link to a PSTN 7 and allow receiving more than one PSTN phone call from different terminals at the same time. Two phone calls (PSTN_1 and PSTN_2) are introduced as an example in the present embodiment. The determination module 600 is configured to receive phone calls from different terminals through the PSTN 7, and assign sound signals of the different phone calls to the wireless earphone 8 and the telephone transmitter 11 one on one. For example, the determination module 600 may link the telephone transmitter 11 through the DECT module 622 when a first phone call (PSTN_1) coming, and transmit the sound signals of the first phone call to the telephone transmitter 11 when the detection module 602 detects the telephone transmitter 11 is removed from the telephone base 6. When a second phone call (PSTN_2) comes as the first phone call is still busy, the determination module 600 may link the wireless earphone 8 through the Bluetooth module 620, and receive a detection signal from the detection module 602 to determine whether the wireless earphone 8 is removed from the telephone transmitter 11. The determination module 600 may further transmit the sound signals of the second phone call to the wireless earphone 8 when the wireless earphone 8 is determined removed from the telephone transmitter 11. Thus, the user(s) of the associated communication apparatus may answer to both phone calls privately, without revealing the content of the phone calls to other people.

On the other hand, when a user uses the wireless earphone 8 and the telephone transmitter 11 to communicate with different terminals through the PSTN 7 at the same time, the multiple parties may be jointed into a conference call so that users of the two terminals and the user of the associated communication apparatus may speak and listen to each other simultaneously. When the function key 64 connected with the determination module 600 is pressed, an activating signal may be generated and sent to the determination module 600. The determination module 600 may retain the phone calls engaged even if the earphone or the transmitter is put back to the base. When the multiple phone calls are engaged at the same time, and the function key 64 is pressed, the determination module 600 may be triggered to determine whether the wireless earphone 8 or/and the telephone transmitter 11 is/are received in corresponding slot (not shown in FIG. 6) by analyzing the detection results of the detection module 602.

When the function key 64 is pressed and then the wireless earphone 8 is detected to be received within the telephone transmitter 11, the determination module 600 may transmit both of the sound signals of the first phone call and the second phone call to the telephone transmitter 11 only, so that the user of the associated communication apparatus may communicate with the two different phone call terminals via the telephone transmitter 11 at one time. Moreover, when the function key 64 is pressed and the telephone transmitter 11 is detected to be received within the telephone base 6, with the wireless earphone 8 removed from the telephone transmitter 11, the determination module 600 may transmit the sound signals of the two phone calls to the wireless earphone 8 only. Thus the user may have a conference call with both of the phone call terminals at the same time without the need to holding a handset and keep the conversation privately.

Furthermore, when the function key 64 is pressed, and the detection module 602 detects that the wireless earphone 8 is put back within the telephone transmitter 11 which is also put back within the telephone base 6, the determination module 600 may transmit the sound signals of the two phone calls to the loud speaker 68 disposed on the telephone base 6, and receive the user's voice via the microphone 66 disposed on the telephone base 6. Therefore, other audience surrounding the associated communication apparatus may also listen to the content of the communications from the two phone call terminals and answer to the phone call terminals publicly. The conference call may be hanged on until the function key 64 is pressed again.

The embodiment illustrated in FIG. 6 may be implemented by the associated communication apparatus related to FIG. 3 or FIG. 4 having corresponding elements. For example, the telephone base 6, the wireless earphone 8, and the telephone transmitter 11 in FIG. 6 may be implemented by the telephone base 10, the wireless earphone 5, and the telephone transmitter 9 in FIG. 3, respectively, or the telephone base 3, the wireless earphone 4, and the telephone transmitter 32 in FIG. 4, respectively.

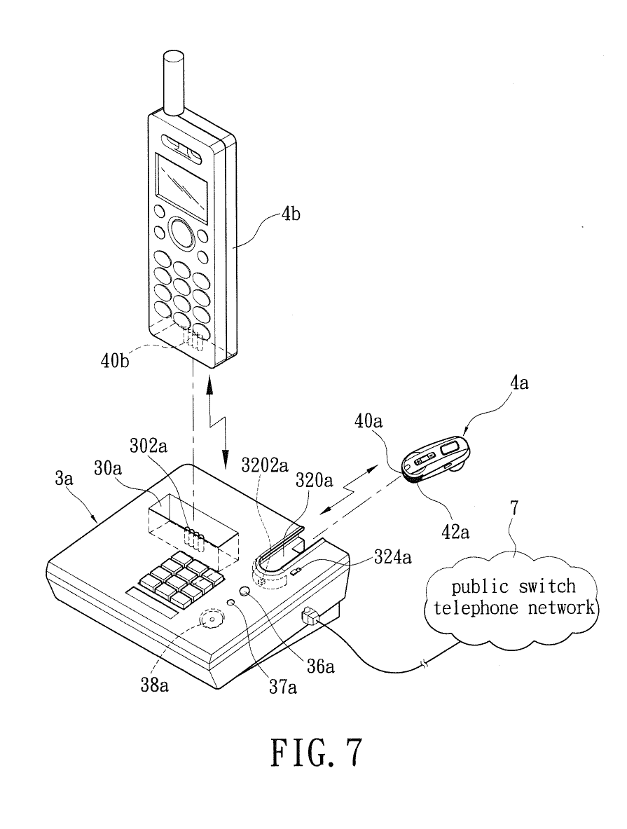

Please refer to FIG. 7 illustrating a schematic diagram of the appearance according to the fourth embodiment of the present invention. In FIG. 7, the telephone transmitter 4b may be received in the transmitter receiving slot 30a while the wireless earphone 4a may be received in the earphone receiving slot 320a. The transmitter receiving slot 30a and the earphone receiving slot 320a are both disposed on the telephone base 3a. The telephone base 3a is also configured with a function key 36a, a microphone 37a, and a loud speaker 38a and other elements already discussed in FIG. 5.

The telephone base 3a may link the PSTN 7 and communicate with phone call terminals via the PSTN 7. The wireless earphone 4a may be a Bluetooth earphone or a DECT earphone, and the telephone transmitter 4b may be a wireless DECT handset. The user may remove the telephone transmitter 4b from the transmitter receiving slot 30a to answer a first phone call via the PSTN 7, and may also remove the wireless earphone 4a from the earphone receiving slot 320a to answer a second phone call via the PSTN 7. When the phone call is still engaged and the telephone transmitter 4b and the wireless earphone 4a are put back to the corresponding slot respectively after the function key 36a is pressed, the sound signals of the phone calls may be broadcasted from the loud speaker 38a and the voice of the user of the associated communication apparatus may be captured by the microphone 37a, and transmitted by the telephone controller 60 to the phone call terminals through the PSTN 7.

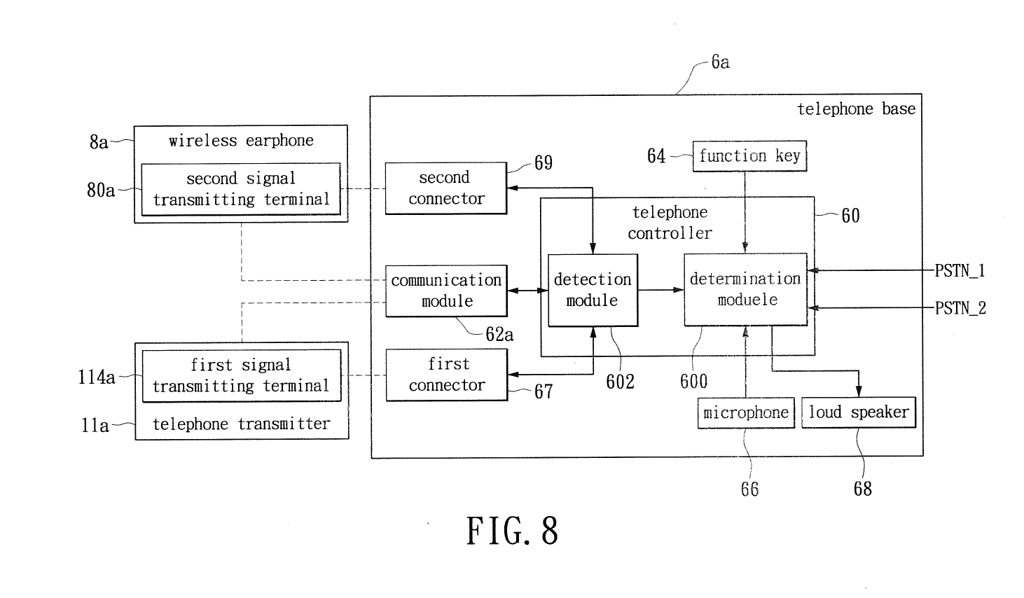

Reference is made to FIG. 8 which shows a block diagram of an associated communication apparatus according to another embodiment of the present invention. In the present embodiment, the telephone base 6a includes a first connector 67 and a second connector 69 respectively corresponding to the first signal transmitting terminal 114 of the telephone transmitter 11a and the second signal transmitting terminal 80 of the wireless earphone 8a. Meanwhile, the communication module 62a of the telephone base 6a configured to communicating with the wireless earphone 8a and the telephone transmitter 11a is a DECT module.

When two phone calls coming from the PSTN 7, the telephone controller 60 may transmit the sound signals of the phone calls to the wireless earphone 8a and the telephone transmitter 11a, respectively, in the beginning. The user of the associated communication apparatus may communicate with different phone call terminals separately by disconnecting the wireless earphone 8a and the telephone transmitter 11a with corresponding connectors 67 and 69. When the second connector 69 is connected with the second signal transmitting terminal 80 again during sound signal transmission, the detection module 602 may detect the connection between the wireless earphone 8a and the telephone base 6a, and the determination module 600 may determine that the wireless earphone 8a is received within the telephone base 6a. Similarly, when the first connector 67 is connected with the first signal transmitting terminal 114 again during sound signal transmission, the determination module 600 may determine that the telephone transmitter 11a is received within the telephone base 6a by analyzing the detection result of the detection module 602.

When the determination module 600 determines that either the wireless earphone 8a or the telephone transmitter 11a is received in the telephone base 6a after the function key 64 is pressed, the determination module 600 may transmit sound signals of both lines of phone calls to the telephone transmitter 11a or the telephone base 6a which is still separated from the telephone base 6a. Therefore the user of the associated communication apparatus may hold a conference call with the terminals from different phone calls, and communicate with the terminals in a private manner.

Furthermore, when the wireless earphone 8a and the telephone transmitter 11a are both detected to be received in the telephone base 6a after the function key 64 is pressed, the determination module 600 may broadcast the sound signals of every phone call in use to the loud speaker 68 of the telephone base 6a and receive the user's voice through the microphone 66 of the telephone base 6a, instead of transmitting sound signals to or from the wireless earphone 8a or telephone transmitter 11a. Therefore the user of the associated communication apparatus may hold a conference call publicly, so that other users surrounding the telephone base 6a may join the conference call as well.

Though only one wireless earphone and one telephone transmitter are discussed in the above-mentioned embodiments, the number of the earphone or the transmitter may be plural, as long as the detection module may detect the connection or disconnection between the telephone base, the wireless earphones, and the telephone transmitters. Hence the associated communication apparatus may receive more than two phone calls concurrently and the determination module may transmit the sound signals of each phone call to a corresponding earphone or transmitter. Furthermore, the function key in the above-mentioned embodiments may be disposed at the wireless earphone other than on the telephone base, and the function key configured on the wireless earphone may electronically connect with the earphone controller that communicates with the telephone base via the communication module. Similarly, the function key may be configured on the telephone transmitter and electronically connected with the transmitter controller, so as to transmit the activating signal to the telephone controller through the transmitter controller and the communication module.

In another embodiment, when the telephone transmitter links to the telephone base in a wired manner as shown in FIG. 4, the first connector and the first signal transmitting terminal may be replaced by a hook switch connected with the telephone controller. The detection module of the telephone controller may detect that the telephone transmitter is received in the telephone base by receiving a signal sent from the hook switch.

To sum up, the associated communication apparatus of the present invention allows the user to install the telephone transmitter into the base and install the wireless earphone into the telephone transmitter or the base. Furthermore, the telephone transmitter can be removed from the base and the wireless earphone can be removed from the telephone transmitter. The associated communication apparatus also allows the user to communicate with different phone call terminals via the wireless earphone and the telephone transmitter respectively at the same time, meanwhile, a conference call joined by the plural phone call terminals and the user may be held in a private or a public manner. Therefore, the present invention provides the user with various means for communication so as to avoid the user's arm from aching when the user has a long call or uses the phone for extended periods, and to increase flexibilities and privacy of telephone communications. The means for communication comprises:

1. Utilizing the telephone base for communicating with at least one terminal or holding a conference call publicly;

2. Utilizing the telephone transmitter for communicating with the terminal or holding a conference call with multiple phone call terminals privately;

3. Utilizing the wireless earphone for communicating with the terminal or holding a conference call with multiple phone call terminals privately.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. An associated communication apparatus for an user to communicate with a phone call terminal of at least one phone call through a PSTN, comprising:
a telephone base, comprising:
a telephone controller for providing PSTN phone call service and transmitting or receiving sound signals;
a transmitter receiving slot, configured with a first connector;
a microphone; and
a loud speaker;
a telephone transmitter, coupled to the telephone base for outputting the sound signals transmitted from the telephone controller and receiving a voice signal of the user, comprising:
a first signal transmitting terminal, wherein the first signal transmitting terminal is electronically connected with the first connector when the transmitter is remove-ably received in the transmitter receiving slot; and
an earphone receiving slot, configured with a second connector;
a wireless earphone, coupled to the telephone base for outputting the sound signals transmitted from the telephone controller and receiving the voice signal of the user, comprising:
a second signal transmitting terminal, wherein the second signal transmitting terminal is electronically connected with the second connector when the wireless earphone is remove-ably received in the earphone receiving slot; and
a function key, coupled to the telephone controller, for generating an activating signal when pressed;
wherein, when the telephone base receives the sound signals of a first phone call and the sound signals of a second phone call through the PSTN while the wireless earphone and the transmitter are removed from the earphone receiving slot and the transmitter receiving slot respectively, the telephone controller transmits the sound signals of the first phone call and the sound signals of the second phone call to the wireless earphone and the transmitter, respectively;
wherein, when the wireless earphone and the transmitter are used to communicate with the phone call terminal of the first phone call and the phone call terminal of the second phone call respectively while the telephone controller receives the activating signal, the telephone controller determines whether the wireless earphone is received in the earphone receiving slot and the transmitter is received in the transmitter receiving slot, and the sound signals of the first phone call and the second phone are switched to be output to the loud speaker and the voice signal of the user is received from the microphone when the wireless earphone and the transmitter are determined to be received in the corresponding slot.

2. The associated communication apparatus according to claim 1, wherein the telephone controller further comprises:
a detection module, for determining whether the transmitter is received in the transmitter receiving slot by detecting whether the first connector is connected with the first signal transmitting terminal, and for determining whether the wireless earphone is received in the earphone receiving slot by detecting whether the second connector is connected with the second signal transmitting terminal; and
a determination module, for determining whether the first phone call and the second phone call are to be transmitted to the wireless earphone and the transmitter respectively or to be output to the loud speaker based on a detection result received from the detection module and the activating signal.

3. The associated communication apparatus according to claim 1, wherein when the telephone controller receives the activating signal and determines one of the wireless earphone and the transmitter is received in the corresponding receiving slot, the telephone controller switches the sound signals of the first phone call and the second phone call to the wireless earphone or the transmitter which is removed from the corresponding receiving slot.

4. The associated communication apparatus according to claim 1, wherein the earphone receiving slot further comprises a magnetic element, and the wireless earphone further comprises an attractable element, the magnetic element attracts the attractable element when the wireless earphone nears the earphone receiving slot.

5. The associated communication apparatus according to claim 1, wherein the function key is disposed on one of the telephone base, the wireless earphone, and the transmitter.

6. The associated communication apparatus according to claim 1, wherein the telephone base further comprises a communication module couple to the telephone controller, and the wireless earphone and the transmitter communicate with the telephone base through the communication module.

7. The associated communication apparatus according to claim 6, wherein the communication module includes a Bluetooth module and a DECT module, the wireless earphone is a Bluetooth earphone communicating with the telephone base through the Bluetooth module, and the transmitter is a DECT transmitter communicating with the telephone base through the DECT module.

8. The associated communication apparatus according to claim 6, wherein the communication module is a DECT module, the wireless earphone is a DECT earphone communicating with the telephone base through the DECT module, and the transmitter is a DECT handset communicating with the telephone base through the DECT module.

9. An associated communication apparatus for an user to communicate with a phone call terminal of at least one phone call through a PSTN, comprising:
a telephone base, comprising:
a telephone controller for providing PSTN phone call service and transmitting or receiving sound signals;
a transmitter receiving slot, configured with a first connector connecting to the telephone controller;
an earphone receiving slot, configured with a second connector connecting to the telephone controller;
a microphone; and
a loud speaker;
a telephone transmitter, coupled to the telephone base for outputting the sound signals transmitted from the telephone controller and receiving a voice signal of the user, comprising:
a first signal transmitting terminal, wherein the first signal transmitting terminal is electronically connected with the first connector when the transmitter is remove-ably received in the transmitter receiving slot;
a wireless earphone, coupled to the telephone base for outputting the sound signals transmitted from the telephone controller and receiving the voice signal of the user, comprising:
a second signal transmitting terminal, wherein the second signal transmitting terminal is electronically connected with the second connector when the wireless earphone is remove-ably received in the earphone receiving slot; and
a function key, coupled to the telephone controller, for generating an activating signal when pressed;
wherein, when the telephone base receives the sound signals of a first phone call and the sound signals of a second phone call through the PSTN while the wireless earphone and the transmitter are removed tong the earphone receiving slot and the transmitter receiving slot respectively, telephone controller transmits the sound signals of the first phone call and the sound signals of the second phone call to the wireless earphone and the transmitter, respectively;
wherein, when the wireless earphone and the transmitter are used to communicate with the phone call terminal of the first phone call and the phone call terminal of the second phone call respectively while the telephone controller receives the activating signal, the telephone controller determines whether the wireless earphone is received in the earphone receiving slot and the transmitter is received in the transmitter receiving slot, and the sound signals of the first phone call and the second phone are switched to be output to the loud speaker and the voice signal of the user is received from the microphone when the wireless earphone and the transmitter are determined to be received in the corresponding slot.

10. The associated communication apparatus according to claim 9, wherein the telephone controller further comprises:
a detection module, for determining whether the transmitter is received in the transmitter receiving slot by detecting whether the first connector is connected with the first signal transmitting terminal, and for determining whether the wireless earphone is received in the earphone receiving slot by detecting whether the second connector is connected with the second signal transmitting terminal; and
a determination module, for determining whether the first phone call and the second phone call are to be transmitted to the wireless earphone and the transmitter respectively or to be output to the loud speaker based on a detection result received from the detection module and the activating signal;
wherein, the first connector and the second connector are electronically connected with the detection module.

11. The associated communication apparatus according to claim 9, wherein when the telephone controller receives the activating signal and determines one of the wireless earphone and the transmitter is received in the corresponding receiving slot, the telephone controller switches the sound signals of the first phone call and the second phone call to the wireless earphone or the transmitter which is removed from the corresponding receiving slot.

12. The associated communication apparatus according to claim 9, wherein the earphone receiving slot further comprises a magnetic element, and the wireless earphone further comprises an attractable element, the magnetic element attracts the attractable element when the wireless earphone nears the earphone receiving slot.

13. The associated communication apparatus according to claim 9, wherein the function key is disposed on one of the telephone base, the wireless earphone, and the transmitter.

14. The associated communication apparatus according to claim 9, wherein the telephone base further comprises a communication module couple to the telephone controller, and the wireless earphone and the transmitter communicate with the telephone base through the communication module.

15. The associated communication apparatus according to claim 14, wherein the communication module includes a Bluetooth module and a DECT module, the wireless earphone is a Bluetooth earphone communicating with the telephone base through the Bluetooth module, and the transmitter is a DECT transmitter communicating with the telephone base through the DECT module.

16. The associated communication apparatus according to claim 14, wherein the communication module is a DECT module, the wireless earphone is a DECT earphone communicating with the telephone base through the DECT module, and the transmitter is a DECT handset communicating with the telephone base through the DECT module.
